(19) United States
(12) Patent Application Publication
(10) Pub. No.: US 2006/0228482 A1
(43) Pub. Date: Oct. 12, 2006

(54) Zinc-aluminum alloy coating of metal objects

(75) Inventors: Massimo Memmi, Rome (IT); Michele Cecchini, Ciampino (RM.) (IT); Claudio Colibri, Rome (IT)

Correspondence Address: PRIEST & GOLDSTEIN PLLC, 5015 SOUTHPARK DRIVE, SUITE 230, DURHAM, NC, 27713-7736, US

(73) Assignee: International Lead Zinc Research Organization, Inc., Research Triangle Park, NC (US)

(21) Appl. No.: 11/100,750

(22) Filed: Apr. 7, 2005

(51) Int. Cl. B05D 3/00; B05D 1/18

(52) U.S. Cl. 427/299; 427/430.1

(57) ABSTRACT

An improved, simplified process is disclosed for non-continuous galvanization of a metal object in a molten Zn—Al alloy bath. Before immersion in the molten alloy, the object is immersed in a dilute hydrochloric solution containing additional chlorides, wherein both of the following occur: (1) The object is pre-coated with a metallic layer of sufficient thickness to protect the object from oxidation, and yet sufficiently thin to permit the pre-coating to substantially completely react with or dissolve in the molten Zn—Al bath, and (2) the pre-coated object is subjected to a surface activation treatment. After removal from the hydrochloric acid solution, the object is allowed to dry, leaving a protective surface coating of a chloride salt. Thereafter, the object is immersed in the Zn—Al bath.

### BACKGROUND OF THE INVENTION

1. Field of the Invention

The invention relates to an improved and simplified process to discontinuously coat metallic objects, by immersion in molten baths of zinc-aluminum alloys.

2. Description of the Related Art

Galvanized steel is widely used where the steel will be exposed to a corrosive atmosphere or other corrosive environment. One important use for corrosion-resistant galvanized steel is in automotive underbody applications.

U.S. Pat. No. 6,284,122 (the “'122 patent”), issued to the assignee of the present application, discloses a coating process wherein metal bodies first are pre-coated with a thin, protective metallic layer comprising, for example, copper, nickel or cobalt. Before the pre-coated metal bodies are immersed in a zinc-aluminum alloy molten bath, these undergo a surface activation treatment by immersion in a diluted solution containing hydrochloric acid. The purpose of the activation treatment is to form a salt layer on the pre-coated surface, which protects the surface from further oxidation prior to immersion in the Zn—Al bath.

By immersing the pre-coated metal object in hydrochloric acid, a reaction between the pre-coating metal and the hydrochloric acid occurs, thereby forming a chloride salt. When the object is removed from the hydrochloric acid solution, the acid solvent is allowed to evaporate, leaving a dry, protective salt layer on the surface of the pre-coated metal object.

While the metallic pre-coating must be adequate to protect the surface of the object from oxidation prior to dipping into the galvanization bath, it also must be sufficiently thin so that, upon subsequent immersion of the object in the Zn—Al bath, the metallic pre-coating either substantially completely reacts with the Al in the Zn—Al bath (such as is the case with a Ni pre-coating, to form an interface Ni—Al compound) or substantially completely dissolves in the bath (such as is the case with a Cu pre-coating), thereby exposing the surface of the metal object to the Zn—Al alloy. The resulting object has a compact, continuous and glossy coating.

As further disclosed in the '122 patent, the concentration of the hydrochloric acid in the activation solution preferably is between 5 and 20% by volume, preferably between 10 and 15%. The solution also may contain an acid ionic or non-ionic surfactant, as well as one or more added chlorides of elements of groups IA, IIA, IB and IIB.

It would be desirable to simplify the above coating process, by reducing the number of steps.

### SUMMARY OF THE INVENTION

The present invention advantageously provides a simplified coating process wherein (1) the pre-coating with a thin, protective metallic layer and (2) the surface activation are combined into a single step. According to the invention, the hydrochloric acid surface activation solution further comprises a chloride selected from the group consisting of CuCl₂, BiCl₃, SnCl₂, ZnCl₂, NH₄Cl, KCl, and combinations thereof.

### DETAILED DESCRIPTION OF THE INVENTION

The disclosure of U.S. Pat. No. 6,284,122 hereby is incorporated by reference herein in its entirety.

In preparation for carrying out the method of the present invention, a metal body first undergoes a “pickling” treatment (to remove rust) in a diluted, aqueous hydrochloric acid solution. After pickling has been completed, the object optionally is rinsed in tap water.

As a next step, the formation of the thin pre-coating onto the metal body preferably is obtained through cementation in a “flux solution,” resulting in a very thin, monoatomic coating. The flux solution typically contains dilute hydrochloric acid. In order to accomplish the surface activation in the same flux solution, an additional chloride, selected from the group consisting of CuCl₂, BiCl₃, SnCl₂, ZnCl₂, NH₄Cl, KCl, and combinations thereof, is added to the flux solution. Solutions containing BiCl₃ are especially preferred.

The diluent for the flux solution is water or an alcohol. The alcohol may be methanol, ethanol, propanol, glycerol and the like, or combinations thereof. The concentration of hydrochloric acid in the flux solution is adjusted to be as low as possible, but high enough to facilitate dissolution of chloride salts. The concentration of the above-identified, added chlorides preferably is from about 1 to about 10% by weight, more preferably from about 1 to about 5%, resulting in a flux solution having a pH not lower than about 2.

The metal body is immersed in the flux solution for about 3 to 4 minutes. The temperature of the flux solution can range from room temperature up to about 60° C., more preferably from about 20 to 30° C.

After the object is removed from the flux solution, the solvent is allowed to evaporate, leaving a dry, protective salt layer on the surface of the pre-coated metal object. A preferred drying method is the use of blown air, at a temperature from about 80 to 100° C., for about 20 to 30 minutes.

Due to the complete evaporation of the solvent, the chloride salts contained in the flux solution precipitate onto the pre-coated surfaces. In general, the chloride salt or mixture of chloride salts should be selected so as to melt at a temperature lower than that of the molten Zn—Al bath (typically between about 300 and 600° C., depending upon the Zn—Al composition). For example, when the object is to be immersed in a molten bath of zinc alloy containing 5% by weight of aluminum (Zn—Al 5%), which has a eutectic temperature of 380° C., the Zn—Al 5% bath preferably is maintained at about 400 to about 450° C. Therefore, the chloride salt should be selected so as to melt at a temperature below about 400 to about 450° C.

Typically, the metal body is immersed in the molten Zn—Al bath (the “hot-dip” step) for from about 1 to 15 minutes, preferably about 5 minutes, and then cooled in air or water. Within the range from about 400 to about 450° C., it is observed that coating thickness and coating density each increase with decreasing temperature.

The following Examples demonstrate certain preferred embodiments of the present invention, without in any way limiting the scope and objects of the invention.

### EXAMPLE 1

(Pre-coating only.) An aqueous flux solution was prepared containing 5 to 20 g/L CuCl₂.2H₂O and 50 g/L HCl. The solution was maintained at room temperature. A steel sample was immersed in the solution for 3 to 4 minutes. The resulting copper coating on the steel had a thickness of about 0.7 μm. The adherence of the layer to the steel was high. No surface activation was performed in this step.

### EXAMPLE 2

In order to utilize a single solution both for pre-coating and surface activation, the following were added to a dilute, aqueous hydrochloric acid solution: CuCl₂.2H₂O (5 to 10 g/L), ZnCl₂ (150 to 180 g/L), BiCl₃ (1 to 2 g/L) and NH₄Cl (20 to 50 g/L). Batches of the solution were maintained at room temperature, 25° C. and 40° C. Steel samples were immersed in each batch of solution for about 3 minutes, resulting in an activated, Cu-deposited layer on the steel.

### EXAMPLE 3

As an alternative to the formulation of Example 2, the following were added to a dilute, aqueous hydrochloric acid solution: CuCl₂.2H₂O (5 to 10 g/L), ZnCl₂ (150 to 180 g/L), SnCl₂ (3 to 4 g/L), NH₄Cl (20 to 50 g/L) and KCl (4 g/L). Batches of the solution were maintained at room temperature, 25° C. and 40° C. Steel samples were immersed in each batch of solution for about 3 minutes, resulting in an activated, Cu-deposited layer on the steel.

### EXAMPLE 4

Pre-coated steel samples, prepared in accordance with Example 2, were subjected to the following processing conditions, including immersion in a molten Zn—Al 5% bath, with the following results:

| Flux | Drying | Drying Time | Hot-dip | Coating |
|---|---|---|---|---|
| Temp(° C.) | Temp(° C.) | (minutes) | Temp(° C.) | Quality |
| r.t. | 150 | 3-15 | 400-450 | Excellent |
| r.t. | 150 | 20-30 | 400-450 | Insufficient |
| 40 | 120 | 3-15 | 400-450 | Excellent |
| r.t. | 80-100 | 20-30 | 400-450 | Excellent |

### EXAMPLE 5

A pre-coated steel sample, prepared in accordance with Example 3, was subjected to the following processing conditions, including immersion in a molten Zn—Al 5% bath, with the following results:

| Flux | Drying | Drying Time | Hot-dip | Coating |
|---|---|---|---|---|
| Temp(° C.) | Temp(° C.) | (minutes) | Temp(° C.) | Quality |
| r.t. | 80-100 | 20-30 | 400-450 | Excellent |

### EXAMPLE 6

(Intergranular corrosion test.) Coated steel samples, prepared in accordance with Examples 4 and 5, were suspended in H₂O vapor at a temperature of 95° C. for 10 days. At the end of the test, the surfaces were examined visually and with a microscope. Visually, no significant differences were observed among the samples. After removal of surface oxidation with Cr₂O₃ 20%, no intergranular attack was observed on the surfaces by microscopic observation.

Though the invention has been described with reference to a treatment in a molten Zn—Al 5% bath, the aluminum content can be varied over a wide range, from about 1 to about 60% by weight, without substantial modifications to the process.

What is claimed is:

1. An improved process for non-continuous galvanization of a metal object with a Zn—Al alloy in a molten Zn—Al alloy bath comprising:
(a) providing a flux solution comprising dilute hydrochloric acid and, in said flux solution,
(i) pre-coating the surface of the metal object with a metallic pre-coating layer so that a uniform, continuous, thin coating of metal is obtained sufficient to protect the surface of the object from oxidation prior to dipping into the galvanization bath, and yet sufficiently thin that the pre-coating can substantially completely react with Al in a molten Zn—Al alloy bath or be substantially completely dissolved in the bath, and
(ii) subjecting the pre-coated surface to a surface activation treatment, thereby forming on the surface of the pre-coated object a protective layer comprising a chloride salt coating having a melting temperature below the temperature of the molten Zn—Al alloy bath; and
(b) dipping the pre-coated metal having the protective chloride salt coating into a molten Zn—Al alloy bath and controlling the temperature and dipping time such that the chloride salt melts and the pre-coating substantially completely reacts with Al in the bath to form an interface compound layer or substantially completely dissolves in the bath, thereby causing the Zn—Al alloy bath to react with the surface of the metal object and form an adherent layer and produce a continuous galvanized coating.

2. The process according to claim 1, wherein the metallic pre-coating layer comprises copper, nickel or cobalt.

3. The process according to claim 2, wherein the metallic pre-coating layer comprises copper.

4. The process according to claim 1, wherein an additional chloride, selected from the group consisting of CuCl₂, BiCl₃, SnCl₂, ZnCl₂, NH₄Cl, KCl, and combinations thereof, is added to the hydrochloric acid solution.

5. The process according to claim 4, wherein the additional chloride is BiCl₃.

6. The process according to claim 1 in which, after the surface activation treatment, the metal object is extracted from the treating solution and directly dried without rinsing.

7. The process according to claim 1, in which the diluent for hydrochloric acid is water or alcohol.

8. The process according to claim 7, in which said alcohol is selected from the group consisting of methanol, ethanol, propanol, glycerol and combinations thereof.

9. The process according to claim 1, in which the pre-coating layer is obtained by cementation.

10. The process according to claim 1, in which the hydrochloric acid concentration in said diluted solution is adjusted to be as low as possible, but high enough to facilitate dissolution of chloride salts in the solution.

11. The process according to claim 4, in which the concentration of said chlorides added to the hydrochloric acid solution is between about 1 and 10% by weight.

12. The process according to claim 11, in which the concentration of said chlorides added to the hydrochloric acid solution is between about 1 and 5% by weight.

13. The process according to claim 1 further comprising, before providing the flux solution, immersing the metal in a diluted, aqueous hydrochloric acid pickling solution, in order to remove rust.
